(19) United States
(12) Patent Application Publication
(10) Pub. No.: US 2021/0086549 A1
(43) Pub. Date: Mar. 25, 2021

(54) Dividing the arc of an angle into "n" number of equal parts.

(71) Applicant: Michael Robert Fried, Oakland, CA (US)

(72) Inventor: Michael Robert Fried, Oakland, CA (US)

(21) Appl. No.: 16/580,542

(22) Filed: Sep. 24, 2019

(51) Int. Cl. B43L 13/00; G01B 3/56

(52) U.S. Cl. CPC B43L 13/002; G01B 3/56

(57) ABSTRACT

Processes for dividing the arc of an angle and its angle into “n” number of equal parts. The same processes apply to dividing the arc of a wave of any amplitude into “n” number of equal lengths. The number of equal divisions to be derived may be either an even number or an odd number. The number of degrees in the arc of a circle or the angle of the circle, or in the arc of a wave or its amplitude, need be known.

### CROSS-REFERENCE TO RELATED APPLICATIONS

None.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO A “SEQUENCE LISTING”

None.

### STATEMENT REGARDING PRIOR DISCLOSURES BY THE INVENTOR

None, other than initial filing of this application on Sep. 24, 2019.

### BACKGROUND OF THE INVENTION

In 1960, Piedmont High School geometry teacher, Mr. Tonascia, presented in class including to the inventor the classic mathematical problem of trisecting any angle using only a compass and a straight edge. That problem has remained unsolved over millennium. Over the years since 1960, the inventor spent time attempting to resolve the trisecting of an angle problem, and determined that the ultimate question was how to divide the arc of an angle not into just three equal parts, but into any number of chosen equal parts and that the question included how to divide the arc of a wave of any amplitude into any number of equal lengths. While some approximations for dividing angles of unknown degrees into three equal parts, methods for dividing angles into even numbers of equal parts, and in some specific cases for dividing angles of known degrees into an odd number of equal parts have appeared, none of those methods is sufficient to divide any arc of any angle or wave or any angle or wave into any number of equal parts desired.

### BRIEF SUMMARY OF THE INVENTION

The applied for patent, “Dividing the arc of an angle into “n” number of equal parts,” provides simple solutions to age old problems of splitting the arc of any angle and its accompanying angle into any number of equal parts desired. The same applies to the arcs of waves of any amplitude into any number of equal lengths. The number of equal parts to be derived may be either an even number or an odd number. The number of degrees in the arc or its angle need not be known. The amplitude of a wave also need not be known.

The results derived from use of any one or more of the exemplary processes herein may have application for other purposes. For example, the processes may offer reform in architectural design, greater mobility with waves and wavelengths including faster ways to broadcast or transmit data, simplified methods of subdividing spacial dimensions without extenuated “string theories.”

Construction need no longer be limited to standard curve designs. Rather, with the exemplified curve dissecting processes herein any angle contemplated for a project can provide the basis for repetitive prefabrication of structure and for appearance in the constituent parts of both surface and facade. The cost savings and other benefits of preforming various sections of structure, surface or facade, which can be manufactured offsite in controlled environments, may allow greater control over materials, design and engineering used in construction projects.

On a smaller scale, for example in furniture manufacturing or interior design, these exemplary processes permit custom pieces to be readily produced and made available from such devices as 3-D image printers or computer generated reduction or cutting devices (like programmable saws, jigs, etc.). Detailed customization can be easily added to mass produced items of décor to satisfy any individual's taste.

Currently much data is streamed, transmitted or broadcast on various wave lengths to such devices that include cell phones, televisions and radios, which read or convert the data for use by the recipient. The compacting of such data streams into bundles by application of the exemplary processes herein and transmitting the compacted data to the device of a recipient can provide deliberate methods for faster transmission of data when the device of the recipient can unbundle such compacted data. Currently, data is included in the wavelengths broadcasting it. If data streams are divided into fixed units with the exemplary arc division processes herein, the more efficient methods for transmitting specific units of continuous data can provide additional possibilities of encryption than currently in use.

Application of the exemplary arc division processes herein can contribute to the balancing of multiple force sources. For a simple example, with a hovercraft that uses three devices to maintain balance, its controls can be programmed to apply the arc division processes herein to balance the combined force output needed from those three devices and automatically adjust the individual devices to maintain the desired relationship of the hovercraft with the surface or other object being hovered. Similar automatic adjustments using the exemplary processes herein as applied to the flight of a hover craft could apply regardless of the number of devices used to maintain craft balance. The automatic application could apply to any objects that use multiple drivers to function or move. For example, if it is important for a craft to keep an even keel, yaw or pitch, these exemplary processes can be automated to control its balance adjusting propulsion units to keep the craft “straight” along its curve of projection.

Likewise, the division of wavelengths into equal parts derived from these exemplary processes can be used to control lighting with adjustments to changing intensity, or vice versa, adjusting intensity to desired lighting. For example, in stage and concert productions a variety of different wavelengths of color are often provided by spotlights generating different colors, with the combination of the generated colors from different spotlights producing a desired color or ambiance on the stage or concert area. During a performance, color effects are often varied or changed by modifying which spotlights are used and their intensity. The exemplary processes herein can divide into equal units the various wavelengths of color generated from such spotlights (with the ranges of their intensities often described in manufacturer specifications). The equal units of color derived from the exemplary processes herein can be combined and automated so that lighting changes, for example for an entire sequence, scene or even the entire production, can be pre-programmed to adjust the output from individual spotlights as desired throughout the performance.

The use of these arc division processes implicate determinations of proper trajectories in space and can suggest appropriate use of propulsion to maintain them. The obvious issue is balancing the potentialities of intervening gravitational and other fields with internal propulsion sources to maximize the distance being traveled. In an ideal universe with unlimited fuel, the maximum distance is reached by continual adjustments to the arc of flight with on-board craft propulsion devices to maximize the positive influence of the changing arcs of gravitational and other fields without those fields having an untowards effect on where the craft seeks to go. No such ideal universe is known to exist. In other words, you want to use the pull of a field without getting pulled in. In reality, a craft cannot carry unlimited fuel. The arc division processes exemplified herein can eliminate some of the guesswork by helping in the determination of the best course(s) in which to proceed through the appropriate space from point to point until the ultimate destination is reached. The exemplary processes can assist in determining the best usage of the applicable forces in play en route and where “gas stations” for the craft may need to be placed along the route of the craft. For example, the use of gravity to minimize consumption of fuel and the minimal amount of fuel needed to counter the various impacts of gravity along the way, and a determination of where to place source of fuel that will be needed to drive the craft to its destination.

With food and drink, application the exemplary processes herein may contribute to the determination of appropriate selections of, for example, seed stock or in genetically modifying organisms. Similar application may apply to the development of medical treatments and drug research and development.

The above examples of use of the exemplary processes herein are merely examples, and not all inclusive. It has been millennia since the question of dividing the arc of an angle into its constituent equal parts has been raised. While not resolving the problem of divided the arc of a circle with merely a straight end and a compass, the exemplary processes herein provide a solution to dividing the arc of an angle and its angle into equal parts, and for the division of an arc of a wave of any amplitude into equal lengths, the uses of which will ultimately be determined by application.

### BRIEF DESCRIPTION OF THE SEVERAL VIEWS OF THE DRAWING

In the following detailed portion of the present description, the teachings of the present application will be explained in more detail with reference to the exemplary processes shown in the drawings, in which:

FIG. 1 is a representation of an arc of a circle and of an arc of a wave.

FIG. 2 is a view of a protractor like device and a parallel pole device.

FIG. 3 is a view of one end of a copy of an arc attached to one of the arms (poles) of a device illustrated in FIG. 2, with the other end of the copy of the arc wrapped around the other arm (pole) of such a device and brought back to the initial arm (pole) of the device.

FIG. 4 is a view of an example of initial processes to divide an arc into an even number of equal parts.

FIG. 5 is a view of an example of initial processes to divide an arc into an odd number of equal parts.

FIG. 6 is a view of where to attach the ends of an arc for odd “n” numbers of equal divisions to the exemplary devices illustrated in FIG. 2.

FIG. 7 is a view of the device in FIG. 2 after being expanded to deform the attached arc into an “n” number of equal length straight lines between the arms (poles) of the device.

FIG. 8 is a view of projecting one of the equal length straight lines formed during the processes of FIG. 7 onto the original arc being divided.

FIG. 9 is a view of dividing an arc into three equal parts.

FIG. 10 is a view of finding the center of the circle created by extending its arc proportionally in its same degree of curve.

FIG. 11 is a view of an example of an arc divided into “n” number of equal parts with a line drawn from the ends of one of the equal part through the center of the arc's circle to form one of the “n” number of equal angles of the circle.

FIG. 12 is a view of an example of an angle of a circle divided into “n” number of equal fractions of that angle.

### DETAILED DESCRIPTION OF THE INVENTION

In the following detailed description, the exemplary processes according to the teachings for this application to divide the arc of any angle and its accompanying angle into any number of desired equal parts will be described by their applications. Such teachings also apply to the division of the arcs of waves of any amplitude into equal parts of equal length. The number of equal parts to be derived may be either an even number or an odd number. The number of degrees in the arc of a circle or its angle need not be known. The amplitude of the wave from which an arc is being divided need not be known. The results derived from use of any one or more of the exemplary processes herein may be used for other purposes.

It should be noted that although only the division of an arc into equal parts are described in the teachings of this application, any one or more of the individual processes described herein or the products and/or results of the application of any one or more of these individual exemplary processes can also be applied to divide other curves into equal parts that are not necessarily fully proportionate in degrees to the length of the entire curve being processed. The letters used in the drawings to identify parts are consistent for the same parts exemplified throughout the different Figures. The Figures are exemplary and not drawn to scale.

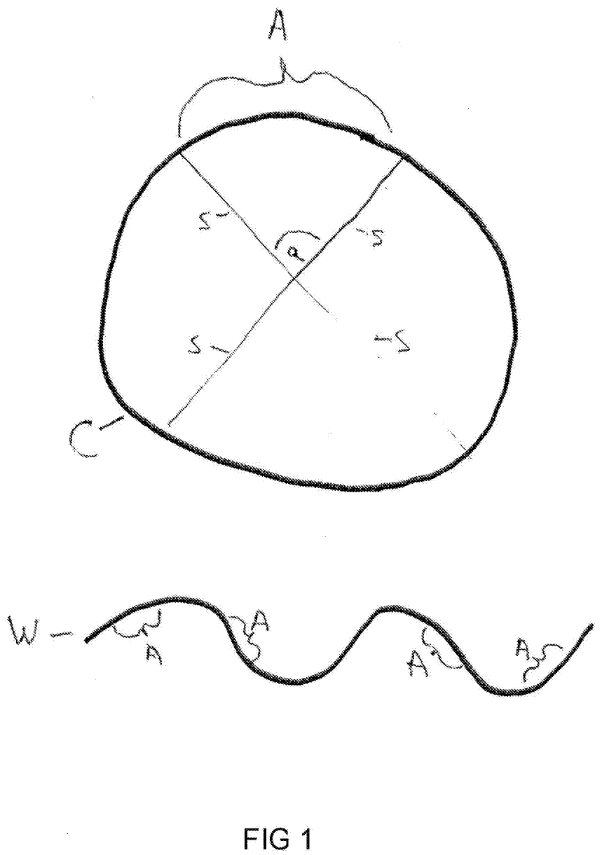

FIG. 1 is a drawing of a representation of an original circle and a wave. The circle is labeled “C” and the wave is labeled “W.” Those parts of the Figures labeled “A” are representations of arcs from their respective circle or a wave. Arc “A” can be any portion of a curved line or wave. If the arc of a circle is extended around following its curve, it will form circle “C.” If lines extending from each end of Arc “A” are drawn through the center of circle “C,” they will be equal sides (labeled “s”) of angle “a” associated with the arc “A.” Arc “A” may be part of a series of arcs such as with some waves, each of which may have similar properties though not necessarily having the same number of degrees of the angle of any other one of them. Neither the number of degrees in angle “a,” nor the length of a side “s” of angle “a,” need be known.

It is understood that arc “A” in its original representational form may not be susceptible to manipulation without destroying that original form. Therefore, the disclosed exemplary processes may use a copy of arc “A” that is of the same proportionate length and curve of arc being divided.

As the exemplary processes disclose, with a physical copy of the arc, a string may be placed (superimposed or projected) over the full length of the copy of the arc to match its curve for an approximation. For greater precision the arc can be electronically duplicated on such a device as an oscilloscope or other electronic device and if desired the electronic copy may transferred for example to computer screen for subsequent manipulation or the manipulation may performed on the same electronic device that copied it or another device such device. An electronically generated copy may be a more precise copy, as one does not have to take into account the physical thickness of the string, how it is wrapped during the subsequent exemplary processes or many of the other things requiring consideration when converting a three dimensional object (such as a string) into the two dimensions of an arc. These copies can then be used in the disclosed exemplary processes without destruction of the original representation. However, if the application of these processes is limited to merely compacting the constituent equal parts of the arc and not reuse the arc in its original form (for example, in some instances where all of part of a compacted wrapped arc from one wave derived by these processes is placed onto a different wave for broadcasting, such as with a data stream), copying may not be necessary and, where the phrase “copy of the arm” is used in the exemplary processes herein the original form or original representation of the arc may be substituted.

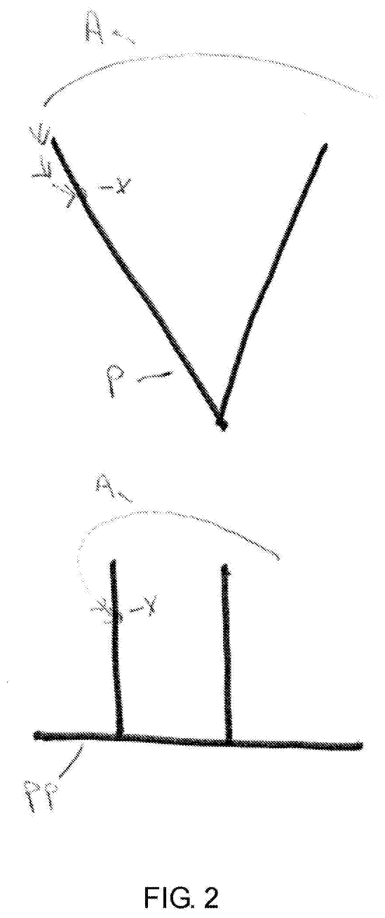

FIG. 2 is an illustration of a protractor like device labeled “P” and a parallel pole device labeled “PP”. The protractor like device “P” may be physical or electronically simulated, and may be currently available or subsequently be created. Either the physical or electronically simulated device has the capabilities of providing functionality similar to a metal compass drawing tool with two arms (sides) that expand from the opposite end of the focal point of the angel where they are joined—as example a protractor. Alternatively, a parallel pole device, labeled “PP” in the Figures has two parallel arms (poles) which can be moved away from or towards each other along a base while the arms (poles) remain parallel. Each of the parallel arms is labeled “pp” in the Figures. For ease, one end of an arm (pole) of “PP” may be fixed perpendicularly to a base with the other arm (pole) movable along the base while remaining parallel to the other arm (pole), or both arms of “PP” can be movable along a base while remaining parallel to each other. While “PP” may be a physical embodiment, its functions may also be simulated electronically.

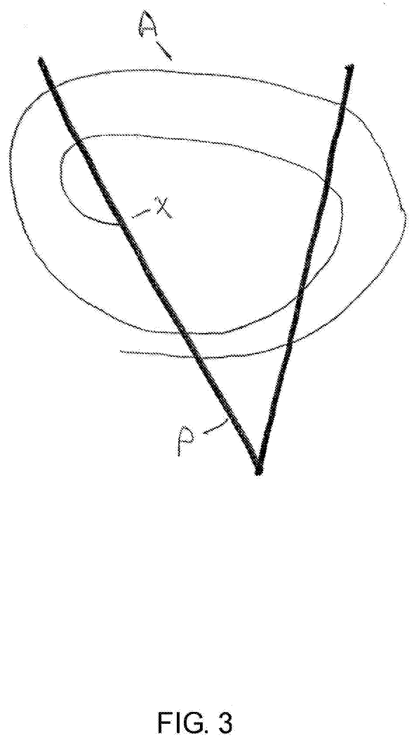

FIG. 3 shows that part of the disclosed exemplary processes that includes attaching one end of the copy of the arc “A” to one arm (pole) of the physical or electronically generated device at any point “x” on the arm (pole).

Part of the disclosed exemplary processes includes wrapping the unattached end of the copy of the arc around the other arm (pole) of the device and bringing it back to the point “x” of attachment of the initial end on the original arm (pole). FIG. 3 is an example of a wrap of arc “A” around a protractor like device “P”.

As the exemplary processes disclose, for an even number of equal parts of arc “A”, the “n” number of times arc “A” is initially wrapped around the device is “n” (the number of desired equal parts of the arc) divided by 2, or n/2=the number of loops around the device for an even “n” number of equal divisions of an arc. For an odd number of equal parts of arc “A”, the “n” number of times arc “A” is initially wrapped around the device is “n” (the number of odd equal divisions of arc “A” desired) minus 1, with the difference divided by 2, or (n−1)/2=the number of initial loops around the device for an odd “n” number of equal divisions of an arc.

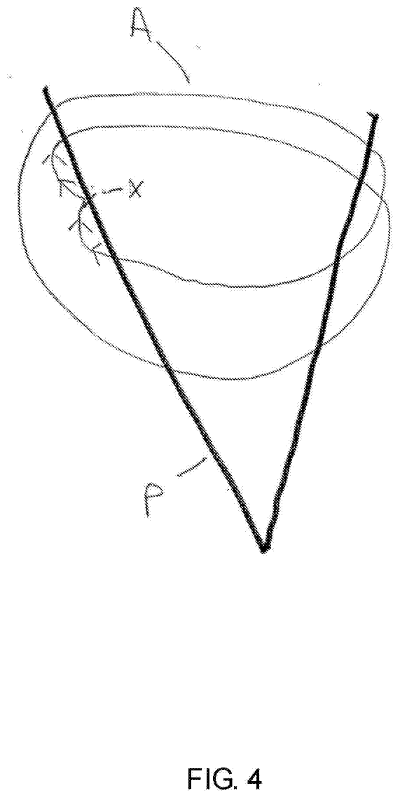

FIG. 4 shows a view of the protractor like device “P” with an arc “A” wrapped for an even number of equal divisions. The view is an example of this stage of the processes after the initial applications shown in FIG. 2 and FIG. 3. For even numbered equal parts, attach the loose end of arc “A” after wrapping n/2 times around the arms (poles) to the same point “x” spot as the original end of arc “A” was attached. Again the number “n” is the even number of desired equal arc divisions sought. Arc “A” is not yet divided into equal parts. This stage of the exemplary processes only provides that for an even number of equal arc divisions, one complete loop from the initial point of attachment of one end of the copy of the arc to a point “x” on one arm (pole) of the device around the other arm (pole) of the device and back to that point “x” of attachment on the original arm (pole) is made for half the “n” number of even arc divisions desired with the unattached end then attached to the original arm at point “x” where is original end was attached. Alternatively, for an even “n” number of equal divisions, both ends of arc “A” can be initially attached to the same point “x” on one arm (pole) of the device, with the loop created placed around the other arm (pole) for one division. If more than a single bisection of the arc is desired, the attached arc is continued to be looped around both arms (poles) with the result appearing as if the original and not alternative process were applied. The total number of loops is equal to half the “n” number of even arc divisions of arc “A” desired, i.e., one initial loop around both poles to divide arc “A” in half, twice around into fourths, three times into sixths, and so forth.

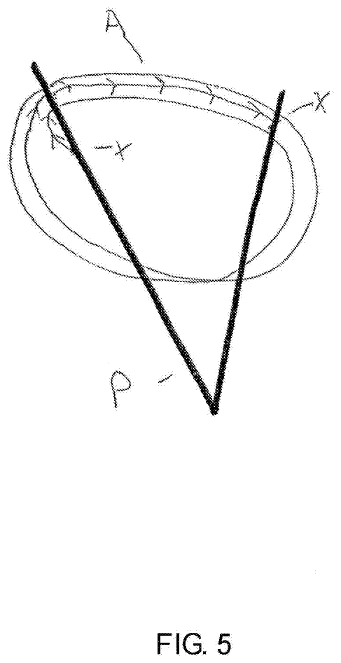

FIG. 5 shows a view of the protractor like device “P” with an arc “A” wrapped for an odd number of equal divisions. For an “n” odd number of equal divisions of arc “A”, after application of the processes exemplified in FIG. 2 and FIG. 3, do not attach the loose end of arc “A” to the original point “x” where its other end was initially attached as is done for “n” even numbers of equal divisions. Instead, after the initial wrapping of arc “A” shown in FIG. 3, continue around the initial arm (pole) past the initial point “x” spot where the other end of arc “A” was attached for an “n” number of even divisions and around to the other arm (pole or side) and attach the loose end of arc “A” to point “x” there. As stated, for an “n” odd number equal divisions, the number of initial loopings around the arms (poles) of the device is (n−1)/2 where “n” is the number of odd equal divisions of arc “A” sought. The continuation of an arc past its original point “x” of attachment on one arm (pole) to the other arm compensates for the difference between even and odd numbers. Again, for an odd number of equal arc divisions, the unattached end of the copy of the arc is wrapped around the other arm of the device with each loop brought back to the point of attachment of its original end on the original arm, except that unlike the processes for an even number of arc divisions, the unattached end of the arc is not affixed to the original point “x” spot on arm (pole) where its other end is already attached. Instead, on the final wrap, the unattached end of the copy of the arc continues to loop around the initial arm (pole) and back to the opposite arm (pole) where it is attached to a point “x” on that arm (pole).

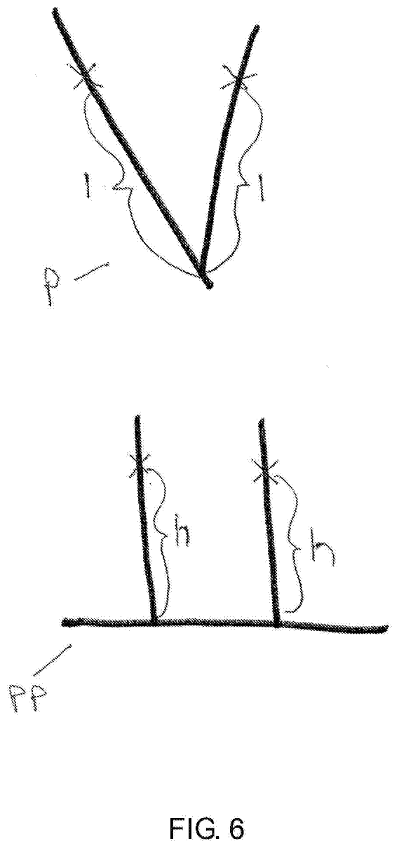

FIG. 6 is a view of an example of where to attach the ends of arc “A” for an “n” odd number of equal divisions to the protractor like device “P” and the parallel pole device “PP”. As illustrated in FIG. 5, for “n” number of odd equal divisions using the protractor like device “P”, the point of attachment “x” of the loose end of arc “A” is on the opposite arm (pole) of “P” from where the initial end of arc A was attached. The point of attachment “x” on that other arm (pole) should be at a point “x” equal distant in length “1” from the focal point of the angle of the protractor like device “P” as is the point “x” of attachment of the original end of arc “A” on the initial arm (pole) of “P”. Using the parallel pole device “PP” for an odd “n” number of equal divisions, the point “x” of attachment of the loose end of arc “A” should be on the opposite arm (pole) from where the initial end of arc “A” was attached at a point “x.” The point “x” of the attachment for the loose end of arc “A” should be at a point equal in height “h” from the base of “PP” as is point “x” where the attachment of the initial end of arc “A” to the original arm (pole) of “PP” occurred.

The exemplary processes disclose an alternative to attaching the loose end of the copy of arc “A” at the end of the looping process. For an even number of equal arc divisions, both ends of the replicated arc “A” are attached to the same point “x” on one of the arms (poles) of the protractor like device or parallel pole device, then the attached arc “A” is looped around both arms or poles half the number of times of even numbers of divisions sought. For an odd number of equal arc divisions, one end of the copy of arc “A” is attached to one arm of the protractor like device or parallel pole device at a point “x”, with the other end of arc “A” attached to the opposite arm (pole) at a point “x” which is equidistant from focal point of the angle of a protractor like device or the base of the parallel poles device as is point “x” of the first attachment, then the replicated arc “A” is looped around both arms (poles) a number of times equal to half the number that is one less than the number of odd divisions sought. For example: for three (3) equal divisions of arc “A”, one loop all the way around both arms would be initial used because 1 is half of 2 (the number that is one less than the 3 equal divisions sought) with the end of arc “A” then continued to the other arm (pole) to include the single additional equal part of arc “A” not included in the calculations. For 5 equal divisions, 2 loops all the way around both arms would be used because 2 is half of 4 (the number that is one less than the five divisions sought) with the end of the arc continued to the other arm (pole) to compensate for the additional equal division sought. The process of continuing back to the opposite arm (pole) after looping arc “A” around both poles is applied for any “n” number of equal odd divisions of arc “A”.

In other words, at this stage of the disclosed exemplary processes, even numbered divisions start and end on the same arm (pole) of the device at a point “x”, while odd numbered divisions start and end on different arms (poles) at points “x” which are equidistant from the focal point of the protractor like device “P” or the base of the parallel pole device “PP”.

At this stage of the disclosed exemplary processes, as shown in FIG. 4 and FIG. 5, both ends of the copy of arc “A” now attached to either an arm or both arms of the protractor like or parallel pole device, and looped not too tightly around both arms (poles). The looping should also not be too loose to inhibit or prevent the next stage of the processes from the stretching arc “A” between the arms (poles) when the arms (poles) are expanded.

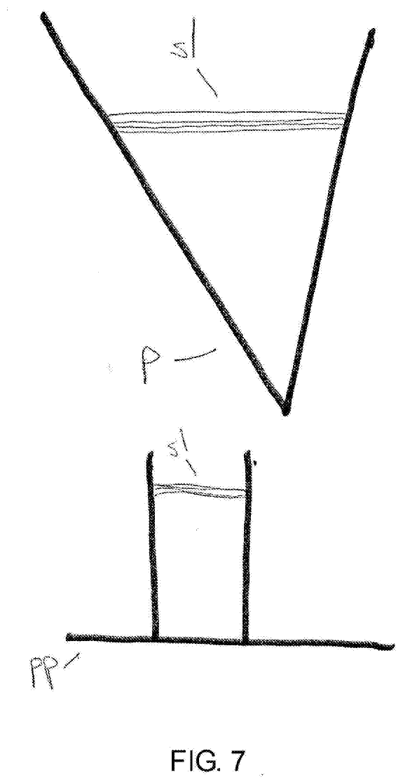

The arms (poles) of the device are now expanded so the looped arc around them is fully stretched taught between them. This expansion is to fully deform the constituent parts of the looped arc “A” into straight lines “sl” between the arms (poles) of the device. The sum of the lengths of straight lines “sl” remains the same total length of arc “A” but no longer has its curve. With the protractor like device “P”, the ends of its arms (poles) that are not attached to the focal of the angle inherent in the device are opened (expanded) until the copy of arc “A” is fully deformed and stretched taught into straight lines “sl” between its arms (poles). For a parallel pole device “PP”, while keeping its arms (poles) parallel, its arms (poles) are expanded away from each other along the base until the copy of arc “A” is fully stretched taught and deformed into straight lines “sl”. The number of taught straight lines “sl” crossing between the arms of either device is equal to the “n” number of equal divisions of the arc being sought. While straight lines “sl” are of equal length and have the combined length of the original replication of arc “A”, they do not have its curve and are not yet an actual division of arc “A” with the degrees of its original curve. The group of straight lines “sl” now compacted have an “n” number of equal straight lines attached to each other so that if unbundled would represent the continuous length of the arc “A” from which they were derived. See FIG. 7 for examples of the straight lines “sl” created on a protractor like device “P” and on a parallel pole device “PP”.

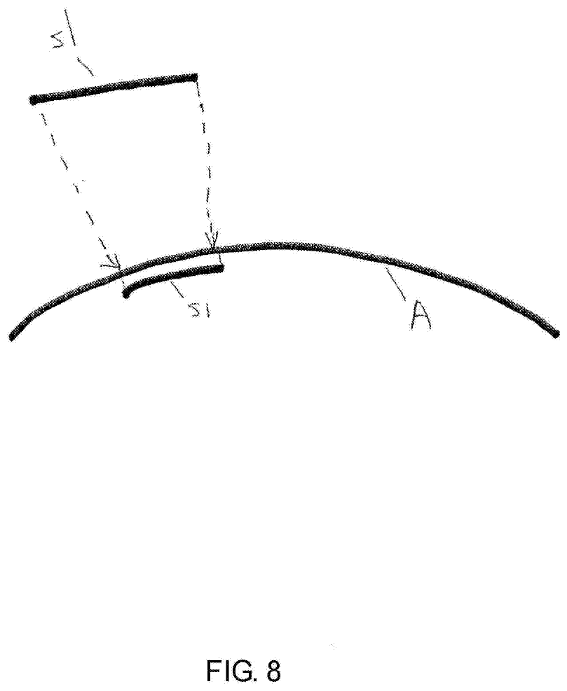

FIG. 8 is a view of placing (projecting or superimposing) one of the straight lines “sl” created as illustrated in FIG. 7 on the initial replication of arc “A” (or the original arc itself when it is in a form amenable for such superimposing). Straight line “sl” is equivalent in length to one of the “n” numbers of divisions of arc “A” that were sought, but not its curve. In this disclosed exemplary process, the straight line is now transposed onto on arc “A” modified to curve of arc “A”. The place occupied on arc “A” by the projected or superimposed straight line “sl” now changed to the curve of arc “A” represents one complete unit of the “n” number of the equal divisions of arc “A” that were sought. If only a single equal unit (1/n fraction) of the arc is desired, it has been created. If more than one single equal “n” division of arc “A” is sought, it is suggested that the initial curving of the straight lines “sl” begin at one end of arc “A” and continue consecutively towards the other end of arc “A”. If the sum of the “n” divisions of straight lines are so applied, arc “A” will be fully divided into all of its “n” equal parts. Again, in an ideal situation of two dimensions, each of the straight lines created on the protractor like device or parallel pole device would be of equal length, with the total numbers of straight lines created on those devices equal to the total whole number of “n” divisions of the arc desired. If the desired “n” number of divisions is not a whole number, it is suggested that the whole number closest to the desired number of division be used to create an initial straight line “sl” following the previously exemplified processes and that the fractional difference between the length of that initial straight line and the actual number of divisions of arc “A” sought be added or subtracted from that initial straight line to create a new straight line “sl” that now becomes the straight line “sl” to be transposed onto the arc of arc “A” to create that non-whole number division of arc “A.”

To repeat, looping the ends of the copy of arc “A” around the arms (poles) of a device with both ends of the copy of the arc starting and stopping at the same point “x” on a single arm (pole) creates an even number of “n” equal divisions, while loops with the ends of the copy of the arc starting at point “x” on one arm (pole) and ending on point “x” of the other arm (pole) creates an odd number of “n” equal divisions. Two straight lines “sl” created on expanding the poles is the basis for dividing the arc into two equal parts. Three straight lines “sl” created on expanding the poles is the basis for dividing the arc into three equal divisions. Four straight lines is the basis for four equal divisions, and so forth, with the “n” number of created equal lines as the basis for dividing the arc into that “n” number of equal divisions.

The exemplary processes illustrated in FIG. 8 of transposing a single straight line “sl” equal division of an arc may be applied to transpose any number of straight line “sl” units of the entire compacted group of single lines “sl” as one or more units onto any arc irrespective of whether that arc is the original arc or not. Each superimposition of this compacted group of straight lines will occupy a position on the arc on which it is projected of one of the “n” numbers of equal divisions of the original arc. Even if one or more of the other processes exemplified herein is not applied, any line whether curved or not may be bundled into a group of equal parts and may likewise be placed on any arc is the example illustrated in FIG. 8 shows for application of a straight line “sl”. For example, if a data stream or any of its parts are compacted into equal parts, the bundle created may be superimposed onto any arc including the arc of a wave regardless of its wavelength.

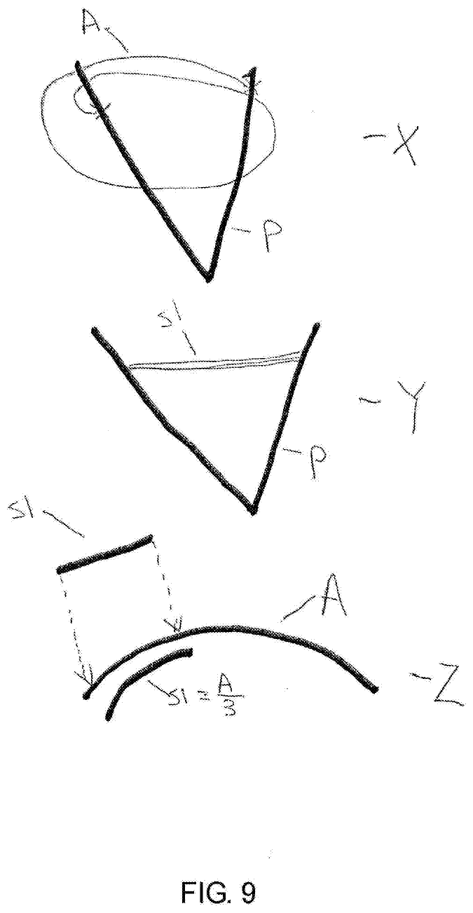

FIG. 9 is a view of the process of dividing arc “A” into three equal parts. Part “X” of FIG. 9 is a view of looping arc “A” one and a half times around device “P”. Part “Y” of FIG. 9 is a view of the deformation of arc “A” by expansion of device “P” into three equal straight lines “sl”. Part “Z” of FIG. 9 is a view of projecting one of the three straight lines “sl” onto the curve of arc “A” with the space occupied on arc “A” by the projection equal to one third of arc “A”.

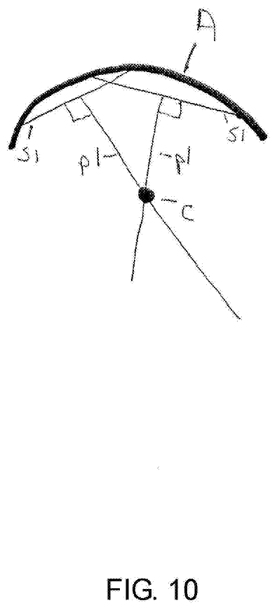

FIG. 10 is a view of how to find the center “c” of circle “C” created when an arc “A” is part of circle and extended around in the same curve of arc “A” to form that circle “C”. Not every one of the arcs labeled “A” in these processes is sufficiently equal in curve to be extended to form a circle. With an appropriately proportional arc “A” from which a circle can be formed, a straight line (“sl”) is drawn between one point on arc “A” of that circle “C” to another point on arc “A” of that circle “C”. The drawn straight line (“sl”) is then bisected between its points of intersection with arc “A” of circle “C”. A perpendicular line “pl” drawn inwards from the point of bisection of a straight line (“sl”) running from one point on arc “A” of circle “C” to another point on arc “A” of circle “C” will intercept the center “c” of circle “C”. If a second straight line (“sl”) is drawn across arc “A” of circle “C” that at least starts or ends at a different point on arc “A” than the first drawn straight line (“sl”) and if this second straight line “sl” is bisected; a perpendicular line “pl” drawn inwards from the point of bisection of this second straight line (“sl”) will intercept center “c” of circle “C”. The two drawn perpendicular lines “pl” will meet at a point “c” which is the center “c” of circle “C”. Neither straight line (“sl”) drawn between points on arc “A” need be of the same length. Again, the illustrations in the various numbered Figures are not drawn to scale, but exemplary.

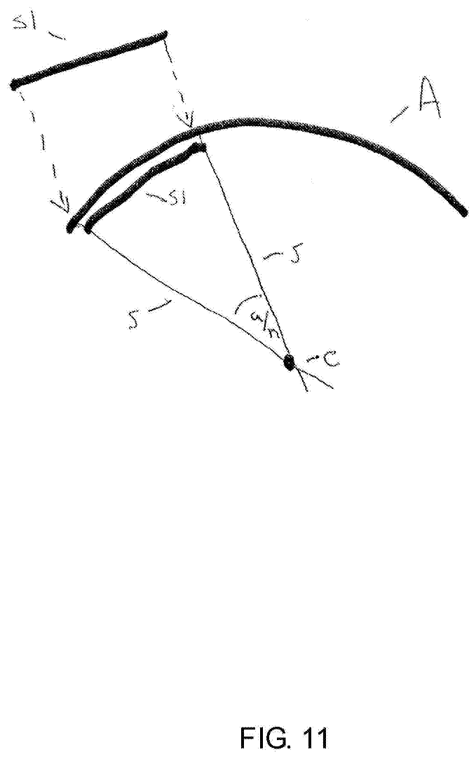

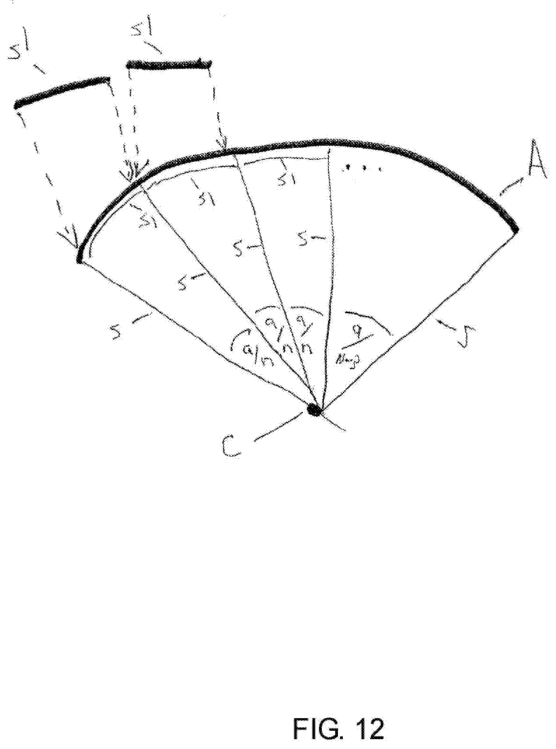

The sought outcome of the application of the exemplary processes herein may not be to merely divide the arc of an angle into equal parts, but to create the actual angle “a” that is one of the “n” equal parts of arc “A”. After applying the processes illustrated in FIG. 10 to find the center of circle “C” of arc “A”, a straight line as illustrated in FIG. 7 is placed, projected or superimposed on arc “A” as illustrated in FIG. 8. FIG. 11 illustrates a line drawn to the center “c” of circle “C” from one end of the now curved straight line “sl” superimposed on arc “A” can define one side “s” of angle “a/n”, one of the “n” number of equal divisions of angle “a”. Another line drawn to the center “c” of circle “C” from the other end of now curved straight line “sl” projected on arc “A” will complete angle “a/n”, an angle that one of the “n” number of equal divisions of angle “a” formed from arc “A”. By beginning placement of the straight lines “sl” at one end of arc “A” and continuing until the entire arc “A” of the angle “a” is divided into “n” number of equal parts, the entire angle “a” may be divided into all of its equal “n” number of fractional angles (“a/n”). See FIG. 12 for an illustration of an angle of a circle divided into “n” number of equal fractions of that angle.

The invention claimed is:

1. A series of processes to divide the arc of a circle and its accompanying angle into any number of desired equal parts. Such processes also apply to dividing the arc of a wave of any amplitude into equal lengths.

2. The processes according to claim 1 provide that the number of equal parts to be derived may be either an even number or an odd number.

3. The processes according to claim 1 provide that number of degrees in the arc or its angle need not be known.

4. The processes according to claim 1 provide that the amplitude or length of the arc of a wave need not be known.

5. The processes according to claim 1 of dividing an arc of a circle into “n” number of equal parts may be extended to divide the angle of any arc into “n” number of equal parts.

6. The processes according to claim 1 provide for deforming the original shape of an arc into “n” number of equal straight lines, the sum of lengths of these straight lines is equal to the length of the arc but without its curve.

7. The processes after deforming an arc into “n” number of equal straight lines according to claim 5, may be continued according to claim 1, with one or more of these straight lines projected or superimposed back onto the arc to match the curve of the arc, wherein each such straight line curved back onto the arc is one of “n” numbers of equal divisions of the arc.

8. The processes according to claim 1, define a method for locating the circle of which an appropriate arc is part of its circumference.

9. The processes according to claim 1, provide that with the identification of center of circle of which an arc is part of its circumference according to claim 8, the end points of the restoration of one of the equal “n” straight lines back to the curve of the original arc according to claim 7 are points providing definition for one of the equal “n” divisions of the angle of the arc, wherein lines are drawn from each end point of that now curved straight line through the center of the circle resulting in a fractional angle that is one of the “n” numbers of equal parts of the angle of original arc.

10. The processes according to claim 9, provide that if placement of the equal “n” number of straight lines on the curve of an arc begins at one end of the arc and continues continuously without gap to its other end, that the arc is equally divided and that lines from the ends of the now “curved” “n” number of straight lines drawn through the center form “n” number of equal divisions of the angle of the arc.

11. Any one or more of the processes and the results derived from the application of any such processes according to claim 1 may have other functions than creating identical equal parts of an arc of a circle or its angle and may be to applied to any curve including a wave of any amplitude.

12. The processes according to claim 7 provide that one application of the processes according to claim 1 is to divide other curves into equal parts, wherein each of the curves “n” equal lengths is not necessarily of the same degree of curvature as any other equal part of the same length derived from the entire curve being processed.

13. The processes according to claim 1 provide for taking the length of an arc and deforming that length into straight lines of “n” number of equal lengths according to claim 6 and any of these “n” number of straight lines may be placed, projected or superimposed onto any arc or wave according to claim 7, wherein the arc or wave need not be the original arc from which the “n” number of its equal parts was derived.

14. The processes according to claim 1, provide the straight lines of “n” equal lengths of the arc being created by continuous looping of an arc according to claim 6, wherein any or all of the number of “n” parts of the straight lines created on stretching the loops may be considered as a single bundle and the entire compacted bundle may be placed, projected or superimposed onto any other arc or wave according to claim 7 as if it were only a single “n” part of the whole.

15. The processes according to claim 1, wherein transposing a single straight line “sl” equal division of an arc illustrated in FIG. 8 may be applied to transpose any number of bundled straight line “sl” units of an entire compacted group of straight lines “sl” as one or more units onto any arc irrespective of whether the straight lines arc from a division of an arc or not.

16. The processes according to claim 15, wherein each superimposition of bundled equal straight lines “sl” units will occupy a position on the arc in which it is projected of one of the “n” of equal divisions of the original arc.

17. The processes according to claim 1, wherein even if one or more of the other exemplary processes is not applied, any line whether curved or straight may bee bundled into a group of equal parts and may likewise be placed on any arc as if it were the single straight line “sl” placed in the example in FIG. 8 shows for application of a single straight line “sl”.

18. The processes according to claim 17, wherein a data stream or any of its parts are compacted into equal parts, the bundle created may be superimposed one any arc including the arc of a wavelength as if it were the single straight line placed as the example in FIG. 8 shows for application of a single straight line “sl”.

19. The processes according to claim 18, wherein a data stream may be compacted into continuous units, attached to any wave for transmission, broadcast or further streaming.

20. The processes according to claim 17, wherein the processes are used for encryptions of specific transmissions of continuous data.

21. The processes according to claim 1, wherein such processes are used for repetitive prefabrication of structure, surface, facade or design of real property.

22. The processes according to claim 1, wherein the processes are used in the design and manufacture of personal property by various devices including 3-D image printers and computer driven reduction or cutting devices.

23. The processes according to claim 1, wherein the processes provide for the balancing of multiple sources of force or propulsion.

24. The processes according to claim 1, wherein the processes provide for the adjustment and control of the intensity, color, quality and quantity of lighting.

25. The processes according to claim 1, wherein the processes are used to determine proper trajectories in space and the use of propulsion to maintain them, including balancing the potentialities of gravitational and other fields with internal craft propulsion sources to maximum the distance being traveled and determine the best usage of applicable forces in play en route.

26. The processes according to claim 1, wherein the processes are applied to determining and producing food stuffs including seed varieties and genetically modified organisms.

27. The processes according to claim 1, wherein the processes are applied to the development of medical treatments and drug research and development.

28. The processes according to claim 1, wherein the processes are used for other applications.
